(19) United States
(12) Patent Application Publication
(10) Pub. No.: US 2007/0254691 A1
(43) Pub. Date: Nov. 1, 2007

(54) Sliding mechanism for use with an electronic device

(75) Inventor: Pen-Wei Lu, Huwei Township (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/785,541

(22) Filed: Apr. 18, 2007

(30) Foreign Application Priority Data
Apr. 28, 2006 (TW) 095115265

(51) Int. Cl. H04M 1/00

(52) U.S. Cl. 455/550.1

(57) ABSTRACT

A sliding mechanism comprises a base, a guiding component, a moving component and a first elastic member. The base includes a first magnetic part. The guiding component is connected with the base. The moving component includes a second magnetic part and is movable along the guiding component. The second magnetic part is disposed corresponding to the first magnetic part. The first elastic member is disposed between the base and the moving component to exert an elastic force on the moving component.

### BACKGROUND OF THE INVENTION

1. Field of the Invention

The present invention relates generally to a sliding mechanism. Particularly, the present invention relates to a sliding mechanism for use with an electronic device.

2. Description of the Prior Art

In addition to the internal functions, the aesthetic attractiveness and the handiness of the consumer electronic products are also important considerations to the customers. Especially in the market of cell phones, the slide-up design is one of the customers' popular.

The slide-up cell phone has a slide cover on the main body. In general, the display screen and the keypad buttons are on the slide cover and the main unit respectively. When the slide cover is pushed up away, the display screen is simultaneously activated and the cell phone is in operation state. When the slide cover is pushed down back, the display screen is simultaneously deactivated and the cell phone is in standby state. This unique design can set the display screen and the keypad buttons on different faces to enlarge the size of the display screen and the region of the keypad buttons to enhance the handiness. Furthermore, the space and the aesthetic attractiveness are also increased by moving the slide cover parallel with the main unit along the guiding rail to open and close the slide cover. The same design concept can be applied to the consumer electronic products, such as electronic dictionary, MP3 player, digital camera, and PDA.

At present, the cell phone user must apply force on the slide cover of the slide-up cell phone during the opening and the closing process to push the slide cover to the particular positions. The handiness of the opening and the closing of the slide cover may be improved.

### SUMMARY OF THE INVENTION

It is an object of the present invention to provide a sliding mechanism to improve the handiness of a translatory object.

It is another object of the present invention to provide an electronic device cover sliding mechanism to improve the handiness of the electronic device cover.

A sliding mechanism comprises a base, a guiding component, a moving component and a first elastic member. The base includes a first magnetic part. The guiding component is connected with the base. The moving component includes a second magnetic part and is movable along the guiding component. The second magnetic part is disposed corresponding to the first magnetic part. A first magnetic force exists between the first magnetic part and the second magnetic part. The first elastic member is disposed between the base and the moving component for exerting an elastic force on the moving component.

The moving component is movable between a first position and a second position along the guiding component. The first position is disposed between the first magnetic part and the second position. The moving component presses the first elastic part to generate a first restoring force smaller than and opposite to the first magnetic force when the moving component is in the first position. The restoring force is larger than the first magnetic force when the moving component is in the second position.

The moving component further includes a first force receiving part for receiving a component force generated along said guiding component from an external force. The sliding mechanism further comprises a first force-exerting component, wherein the first force-exerting component is disposed corresponding to the force receiving part.

In the preferred embodiment, the base further includes a third magnetic part, wherein the third magnetic part is disposed in one side of the base opposite to the first magnetic part. Besides, the moving component further includes a fourth magnetic part, wherein the fourth magnetic part is disposed corresponding to the third magnetic part. A second magnetic force exists between the third magnetic part and the fourth magnetic part. The moving component is movable between a third position and a fourth position along the guiding component. The third position is disposed between the third magnetic part and the fourth position.

The sliding mechanism further comprises a second elastic member being disposed between the base and the fourth magnetic part of the moving component to exert an elastic force on the moving component. The moving component presses the second elastic part to generate a second restoring force smaller than and opposite to the second magnetic force when the moving component is in the third position. The second restoring force is larger than the second magnetic force when the moving component is in the fourth position.

### BRIEF DESCRIPTION OF THE DRAWINGS

FIG. 1 is a schematic diagram of a preferred embodiment of the present invention used on a cell phone.

FIG. 2a is a schematic diagram of an embodiment of the present invention.

FIG. 2b is a schematic diagram of an embodiment of the present invention with different set of the magnetic parts.

FIG. 2c and FIG. 2d are schematic views showing the movement related to the forces applied on a preferred embodiment of the present invention.

FIG. 3a and FIG. 3b are schematic diagrams of embodiments of the present invention with different types of deformable objects of the first elastic member.

FIG. 4a and FIG. 4b are embodiments of the present invention with different sets of the first elastic member.

FIG. 5a to FIG. 5c are schematic views showing the movement related to the forces applied on a preferred embodiment of the present invention further including a first force-exerting component and a first force receiving part.

FIG. 5d is an embodiment of the present invention with different set of the first force receiving part.

FIG. 5e is a schematic view showing the movement related to the forces applied on a preferred embodiment of the present invention further including a third magnetic part and a fourth magnetic part.

FIG. 6a to FIG. 6c are schematic views showing the movement related to the forces applied on a preferred embodiment of the present invention further including a second elastic member.

FIG. 7a to FIG. 7b are schematic views showing the movement related to the forces applied on a preferred embodiment of the present invention further including a second force-exerting component and a second force receiving part.

FIG. 7c is a schematic diagram of a preferred embodiment of the present invention.

FIG. 8 is a disassembly view of the preferred embodiment of the present invention used on a slide-up cell phone.

### DETAILED DESCRIPTION OF THE PREFERRED EMBODIMENT

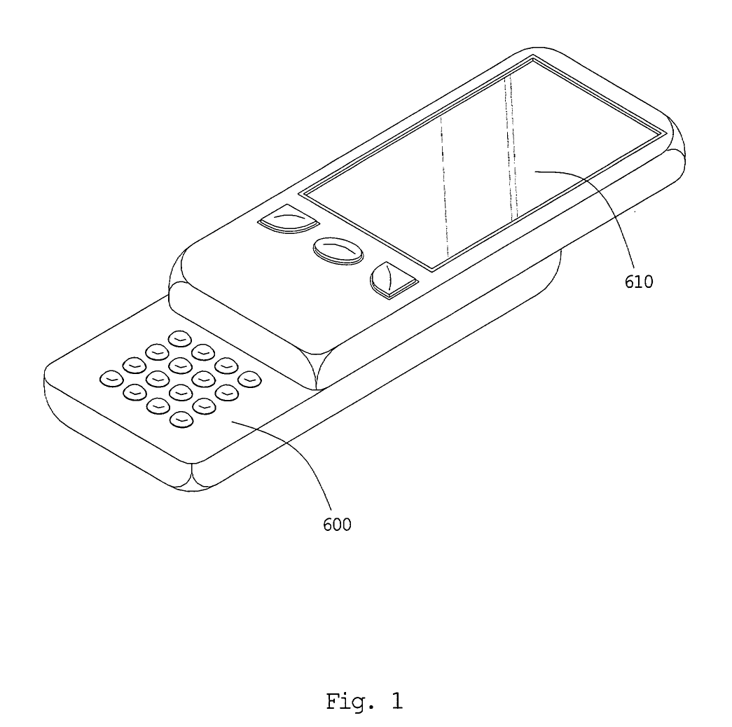

The present invention provides a sliding mechanism. As shown in FIG. 1 refers to a preferred embodiment, wherein the sliding mechanism is for the opening and the closing of the slide cover of the slide-up cell phone. In another embodiment, however, the sliding mechanism may be applied to other object moves along a guiding component.

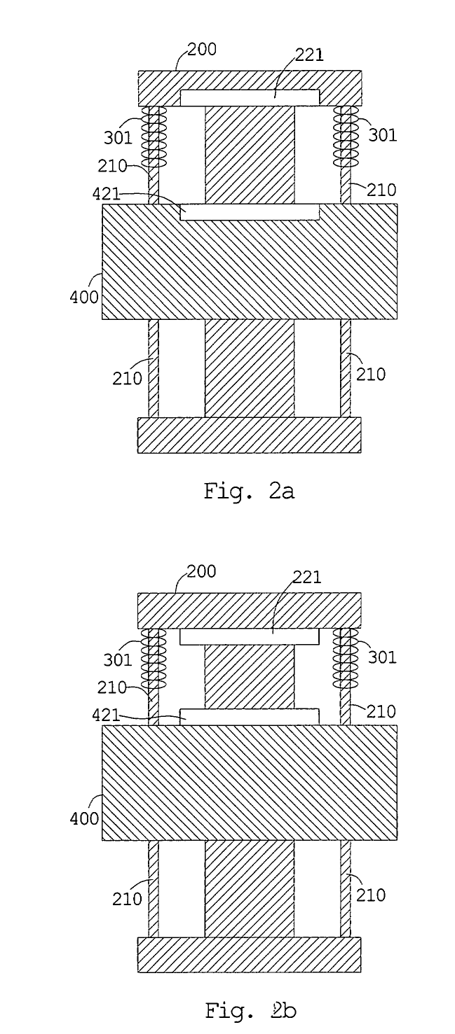

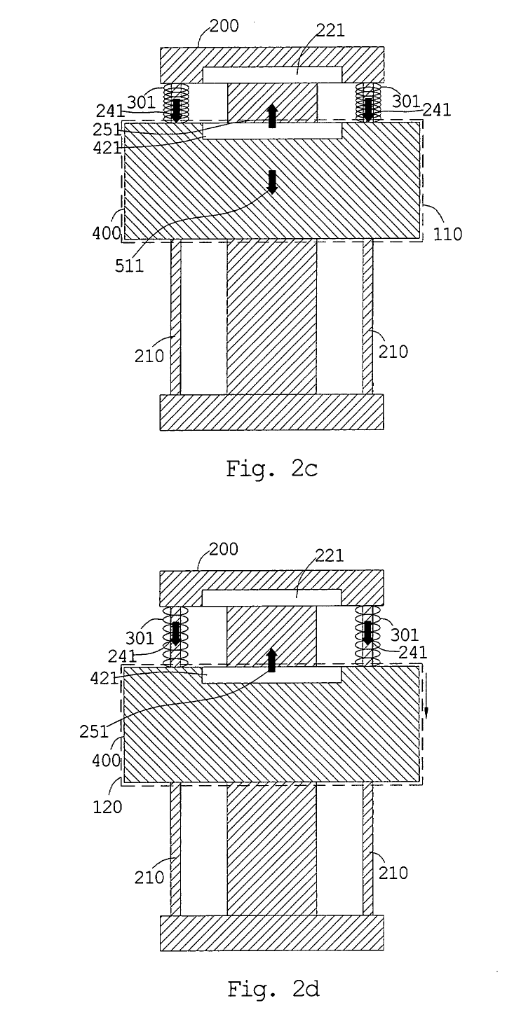

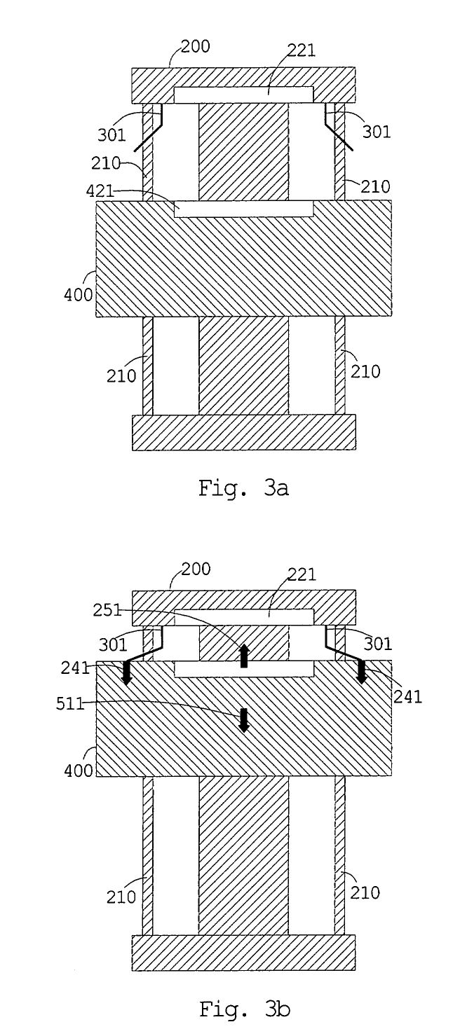

The sliding mechanism includes a base 200, a guiding component 210, a moving component 400 and a first elastic member 301. With reference to FIG. 2a, in a preferred embodiment, the base 200 includes a first magnetic part 221. The guiding component 210 is connected with the base 200. The guiding component 210 may be a rail, a groove or a pivot object. The guiding component 210 may be singular or plural. In the preferred embodiment, the guiding component 210 is a pair of rail.

This pair of rail is both connected with the base 200 and extends from the first magnetic part 221 to the other side of the base 200.

The first magnetic part 221 is not limited to integratedly formed with the base 200. In the embodiment as shown in FIG. 2b, the first magnetic part 221 is disposed on the surface of the base 200. The magnetic part may be a magnetism included part or a magnetic force attractable part such as magnet and metal plate.

The moving component 400 includes a second magnetic part 421 and is movable along the guiding component 210. The second magnetic part 421 is disposed corresponding to the first magnetic part 210. The moving component 400 may be further connected with a carrier (not shown). The carrier is movable together with the moving component 400. In the preferred embodiment, the carrier is a slide cover.

The second magnetic part 421 is disposed on the moving component 400 corresponding to the first magnetic part 221. The second magnetic part 421 is not limited to integratedly formed with the moving component 400. In the embodiment shown in FIG. 2b, the second magnetic part 421 is disposed on the surface of the moving component 400.

In a preferred embodiment shown in FIG. 2c and FIG. 2d, the moving component 400 is movable between a first position 110 and a second position 120 along the guiding component 210. The first position 110 is disposed between the first magnetic part 221 and the second position 120. A first magnetic force 251 exists between the first magnetic part 221 and the second magnetic part 421.

Besides, the fist elastic member 301 is disposed between the base 200 and the moving component 400 to exert an elastic force on the second magnetic part 421 of the moving component 400. The elastic member of the present invention may be an object generates deformation when a force is applied on such as a spring, an elastic rubber and an elastic plate. The aforementioned deformation includes compression, strain draw and bend.

The moving component 400 presses the first elastic part 301 to generate a first restoring force 241. The first restoring force 241 is opposite to and smaller than the first magnetic force 251 when the moving component 400 is in the first position 110. At this time, the moving component 400 stays in the first position 110. The moving component 400 moves in the direction toward the second position 120 along the guiding component 400 when a first transient force 511 applies on the moving component 400, wherein the sum of the first transient force 511 and the first restoring force 241 is larger than the first magnetic force 251.

Since the strength of the magnetic force and the elastic force are inversely proportional to the square of the distance and the distance itself respectively, the first restoring force 241 is larger than the first magnetic force 251 in the second position 120 after the moving component 400 is sprung by the first elastic part 301. The moving component 400 moves to the opposite side of the first magnetic part 221 of the base 200 along the guiding component 210.

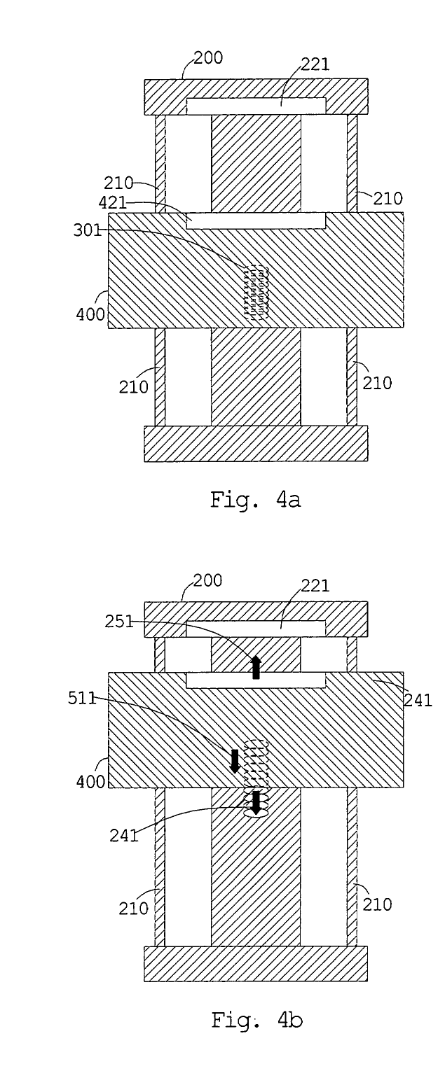

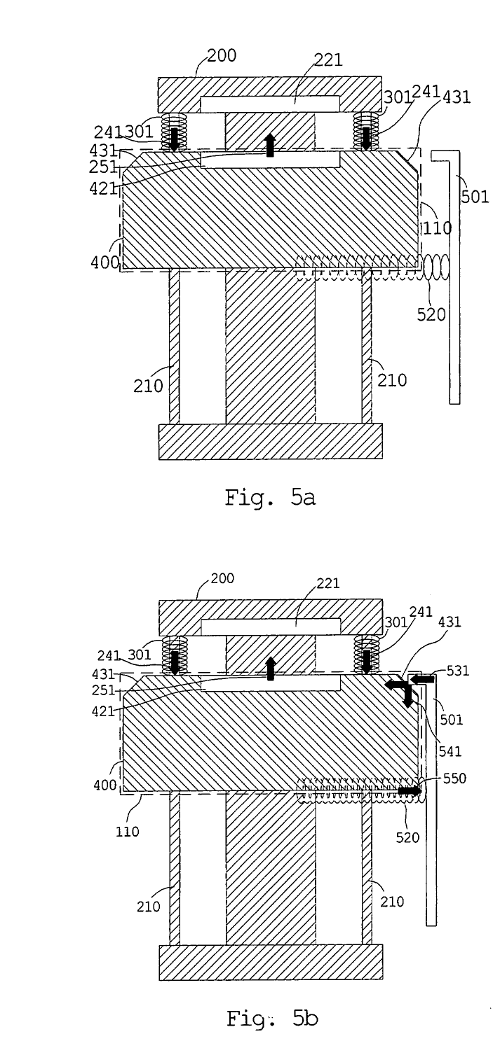

In the preferred embodiment shown in FIG. 2c and FIG. 2d, the first elastic part 301 is a spring and is disposed on the base 200. In other embodiments, however, the first elastic part 301 may be other deformable object or may be disposed in other location to generate the first restoring force 241. In other embodiments shown in FIG. 3a and FIG. 3b, an elastic plate may be used to replace a spring as the elastic member 301. In other embodiments shown in FIG. 4a and FIG. 4b, a spring is used as the elastic member 301. The spring is disposed on the base 200 and connected with the moving component 400.

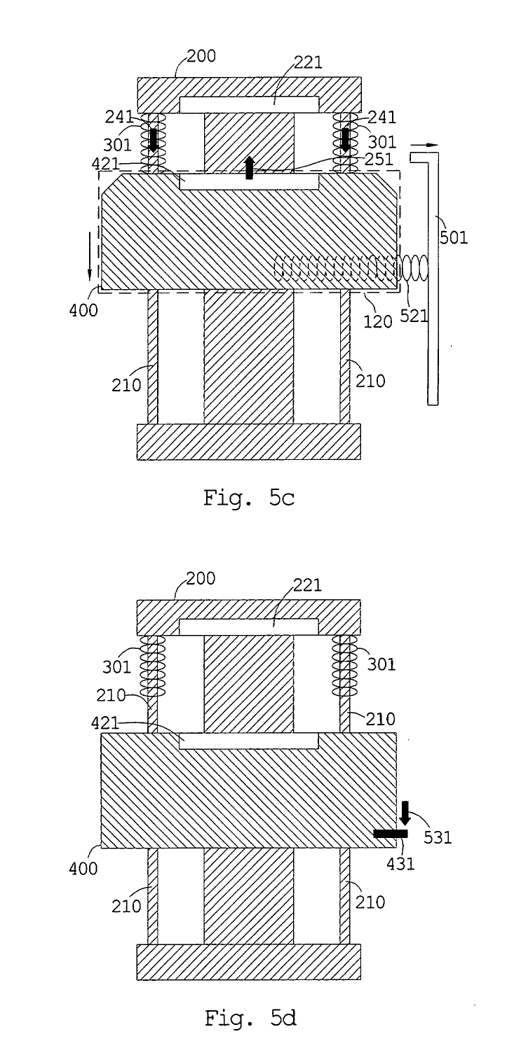

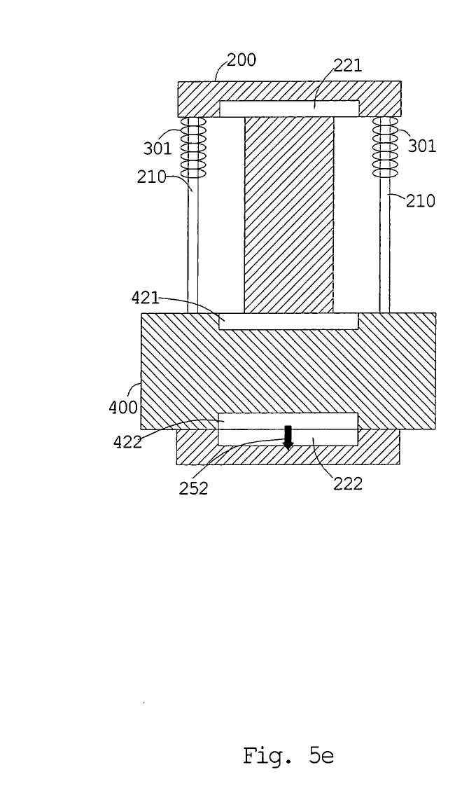

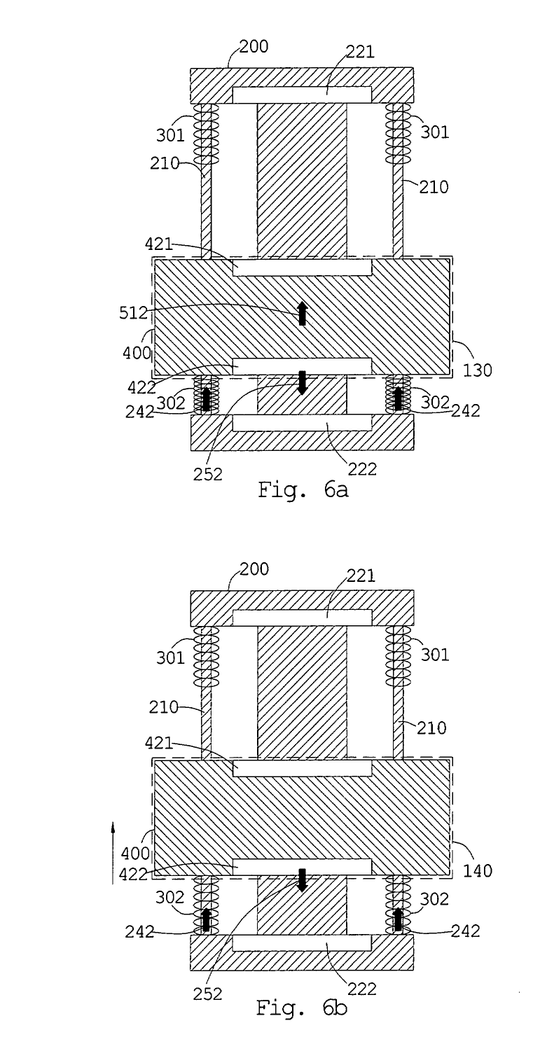

In the preferred embodiment shown in FIG. 5a to FIG. 5c, the moving component 400 further includes a first force receiving part 431, wherein the first force receiving part 431 includes a inclinatory surface. The first force receiving part 431 receives a first component force 541 generated along the guiding component 210 from an external force 531. With reference to FIG. 5d, in another embodiment, the first force receiving part 431 is an outthrust to be applied a force by the first external force 531.

In the preferred embodiment shown in FIG. 5a, the sliding mechanism further comprises a first force-exerting component 501, wherein the first force-exerting component 501 is disposed corresponding to the force receiving part 431. The first force-exerting component 501 is disposed outside the base 200 and is movable toward the base 200.

In the preferred embodiment, the first force-exerting component 501 further includes an elastic part 520. When a first force-exerting component 501 moves toward the base 200, the elastic part 520 deforms and generates a first rebound force 550 in direction opposite to the direction of the movement of the first force-exerting component 501. With reference to FIG. 5a, in a preferred embodiment, the rebound 520 is a spring, wherein the spring is disposed on the base 200. However, in another embodiment, the rebound 520 may be other deformable object or may be disposed in other location to generate the first rebound force 550 toward the base 200.

In the preferred embodiment shown in FIG. 5a to FIG. 5c, the moving component 400 moves in the direction toward the second position 120 along the guiding component 400 when the first component force 541 applies on the moving component 400. Wherein the direction of the first component force 541 is same with the first restoring force 241 and the sum of the first transient force 511 and the first restoring force 241 is larger than the first magnetic force 251.

In the preferred embodiment shown in FIG. 5e, the base 200 further includes a third magnetic part 222. The third magnetic part 222 is disposed on the opposite side of the base 200 corresponding to the first magnetic part 221.

In the preferred embodiment shown in FIG. 5e, the moving component 400 further includes a fourth magnetic part 422. The fourth magnetic part 422 is disposed corresponding to the third magnetic part 222, wherein a second magnetic force 252 exists between the third magnetic part 222 and the fourth magnetic part 422. After the moving component 400 is sprung by the first elastic part 301, the moving component 400 moves toward the third magnetic part 222 and is attracted by the second magnetic force 252 to stay in the side near the third magnetic part 222 of the base 200.

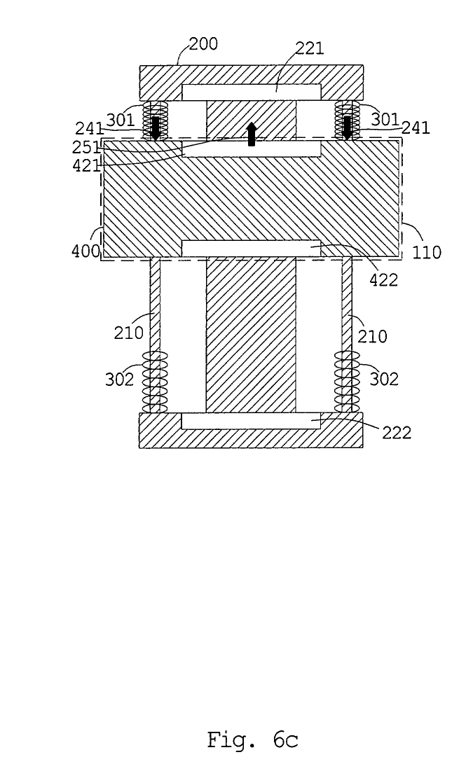

In the preferred embodiment shown in FIG. 6a, the sliding mechanism further comprises a second elastic member 302 being disposed between the base 200 and the fourth magnetic part 422 of the moving component 400 to exert an elastic force on the moving component 400. As shown in FIG. 6a, the second elastic part 302 is a spring and is disposed on the base 200. In other embodiment, however, the second elastic part 302 may be other deformable object, such as an elastic plate, or may be disposed in other location to generate the second restoring force 242.

In the preferred embodiment shown in FIG. 6a and FIG. 6b, the moving component 400 is movable between a third position 130 and a fourth position 140 along the guiding component 210. The third position 130 is disposed between the third magnetic part 222 and the fourth position 140. With reference to FIG. 6a, after the moving component 400 is sprung by the first elastic part 301, the moving component 400 moves toward the third magnetic part 222. The inertial force of the moving component 400 and the second magnetic force 252 together overcome the second restoring force 242 to move the moving component 400 to the third position 130.

In the preferred embodiment shown in FIG. 6a, the moving component 400 presses the second elastic part 302 to generate a second restoring force 242 smaller than the second magnetic force 252 when the moving component 400 is in the third position 130. At this time, the moving component 400 stays in the third position 130. The moving component 400 moves in the direction toward the fourth position 140 along the guiding component 400 when a second transient force 512 applies on the moving component 400, wherein the direction of the second transient force 512 is same with the second restoring force 242 and the sum of the second transient force 512 and the second restoring force 242 is larger than the second magnetic force 252.

In the preferred embodiment shown in FIG. 6a, since the strength of the magnetic force and the elastic force are inversely proportional to the square of the distance and the distance itself respectively, the second restoring force 242 is larger than the second magnetic force 252 in the fourth position 140 after the moving component 400 is sprung by the second elastic part 302. The moving component 400 moves toward the first magnetic part 221 of the base 200 along the guiding component 210.

In the preferred embodiment shown in FIG. 6c, after the moving component 400 is sprung by the second elastic part 302, the moving component 400 moves toward the first magnetic part 221. The inertial force of the moving component 400 and the first magnetic force 251 together overcome the first restoring force 241 to move the moving component 400 to the first position 110.

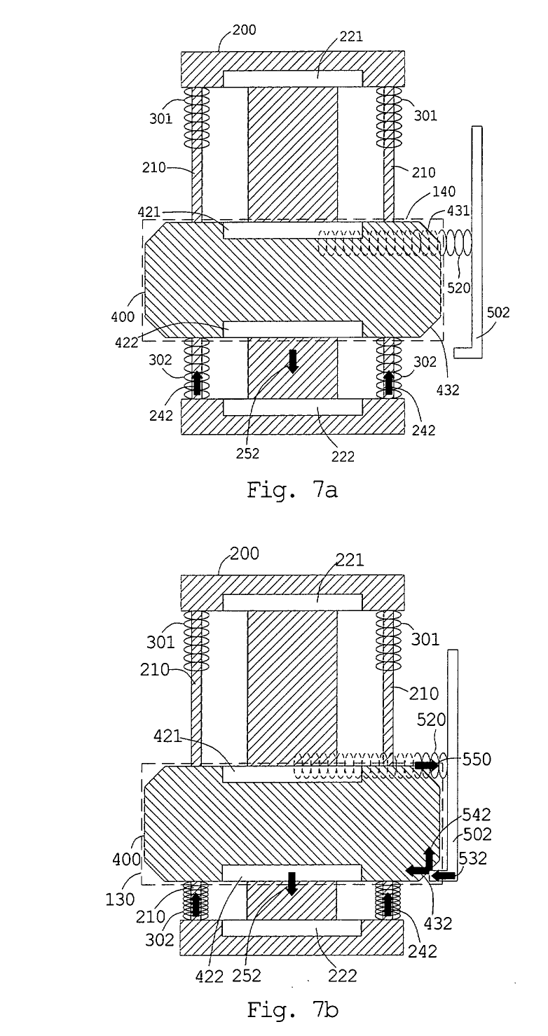

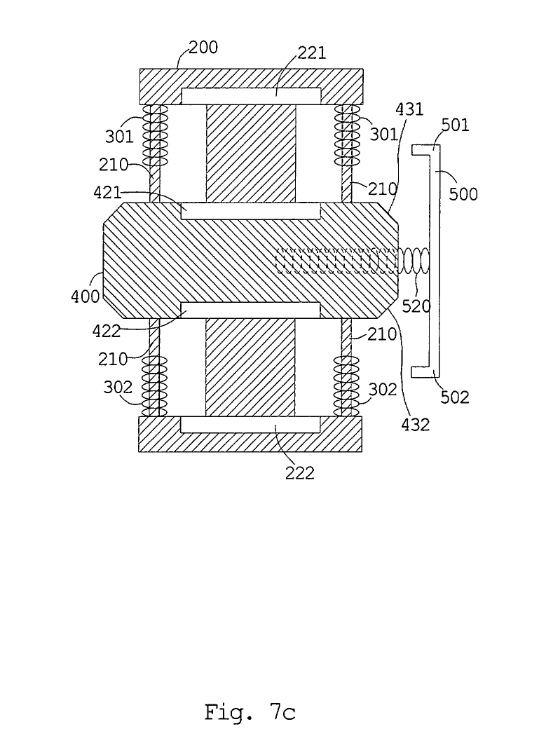

In the preferred embodiment shown in FIG. 7a and FIG. 7b, the moving component 400 further includes a second force receiving part 432, wherein the second force receiving part 432 includes a inclinatory surface. The second force receiving part 432 receives a second component force 542 generated along the guiding component 210 from a second external force 532.

In the preferred embodiment shown in FIG. 7a and FIG. 7b, the moving component 400 moves in the direction toward the fourth position 140 along the guiding component 400 when the second component force 542 applies on the moving component 400. Wherein the direction of the second component force 542 is same with the second restoring force 242 and the sum of the second component force 542 and the second restoring force 242 is larger than the second magnetic force 252.

In the preferred embodiment shown in FIG. 7a and FIG. 7b, the sliding mechanism further comprises a second force-exerting component 502, wherein the second force-exerting component 502 is disposed corresponding to the second force receiving part 432. The second force-exerting component 502 is disposed outside the base 200 and is movable toward the base 200.

In another embodiment, the first force-exerting component 501 and the second force-exerting component 502 may be individually disposed corresponding to the first force receiving part 431 and the second force receiving part 432 respectively. However, In the preferred embodiment shown in FIG. 7c, the first force-exerting component 501 may combines with the second force-exerting component 502 to form a combination force-exerting component 500. Wherein the first force-exerting component 501 and the second force-exerting component 502 of the combination force-exerting component 500 are disposed corresponding to the first force receiving part 431 and the second force receiving part 432 respectively.

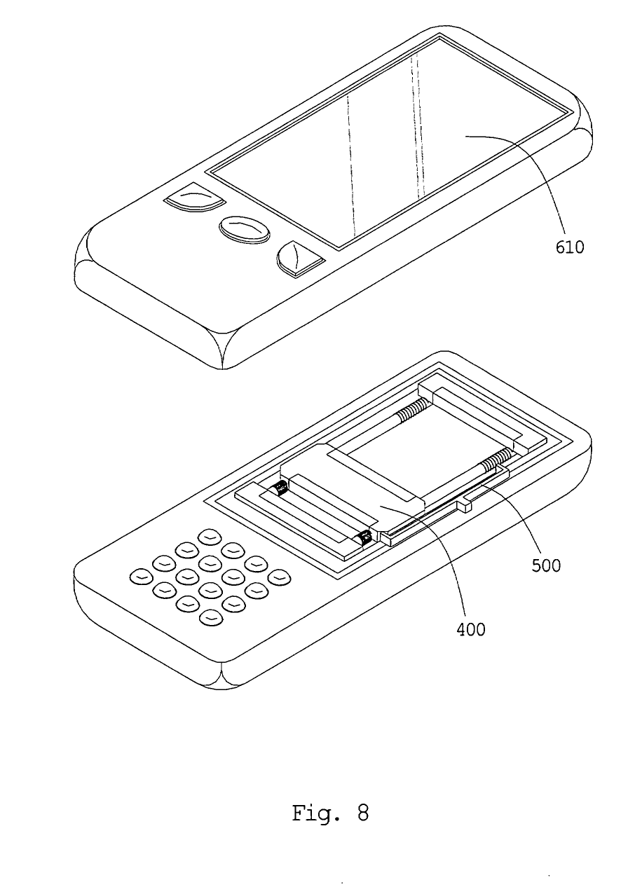

The sliding mechanism further comprises a carrier 600 connected to the moving component and is movable together with the moving component 400. The carrier 610 preferably includes an electronic device cover. In the preferred embodiment shown in FIG. 8, the electronic device cover is a slide cover of a slide-up cell phone. When a user presses the combination force-exerting component 500 once, the slide cover is pushed up away automatically. The display screen is simultaneously activated and the cell phone is in operation state. When the user presses the combination force-exerting component 500 once again after he finished using, the slide cover is pushed down back automatically. The display screen is simultaneously deactivated and the cell phone is in standby state. In other words, the slide cover may be sequently automatically pushed up away and down back by pressing the combination force-exerting component 500 by the user without entirely pushing the slide cover to a desired position. In other embodiment, the electronic device cover may be a cover of a digital camera or a personal digital assistant.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A sliding mechanism, comprising:
a base having a first magnetic part;
a guiding component connected with said base;
a moving component having a second magnetic part, wherein said moving component is movable along said guiding component and said second magnetic part is disposed corresponding to said first magnetic part; and
a first elastic member, disposed between said base and said second magnetic part of said moving component, for exerting an elastic force on said moving component.

2. The sliding mechanism of claim 1, wherein a first magnetic force exists between said first magnetic part and said second magnetic part.

3. The sliding mechanism of claim 2, wherein said moving component is movable between a first position and a second position along said guiding component, said first position is located between said first magnetic part and said second position, and said moving component presses said first elastic part to generate a first restoring force, the first restoring force is smaller than and opposite to said first magnetic force when said moving component is in said first position.

4. The sliding mechanism of claim 3, wherein said restoring force is larger than said first magnetic force when said moving component is in said second position.

5. The sliding mechanism of claim 1 further comprising a carrier connected to said moving component, wherein said carrier is movable together with said moving component.

6. The sliding mechanism of claim 1, wherein said moving component further includes a first force receiving part for receiving a component force generated along said guiding component from an external force.

7. The sliding mechanism of claim 6, wherein said first force receiving part includes an inclinatory surface for redirecting the external force exerted on the inclinatory surface to a direction along the guiding component.

8. The sliding mechanism of claim 6 further comprises a first force-exerting component, wherein said first force-exerting component is disposed corresponding to said first force receiving part.

9. The sliding mechanism of claim 8, wherein said first force exerting component is disposed outside said base and is movable toward said base.

10. The sliding mechanism of claim 8, wherein said first force exerting component further includes an elastic part, wherein when a first force-exerting component moves toward the base, the elastic part deforms and generates a rebound force in direction opposite to the direction of the movement of the first force-exerting component.

11. An electronic device, comprising:
a sliding mechanism, comprising:
a base having a first magnetic part;
a guiding component connected with said base;
a moving component having a second magnetic part, wherein said moving component is movable along said guiding component and said second magnetic part is disposed corresponding to said first magnetic part; and
a first elastic member being disposed between said base and said second magnetic part of said moving component to exert an elastic force on said moving component;
a cover connecting to said moving component, wherein said cover is movable together with said moving component; and
a shell connecting with said base.

12. The electronic device of claim 11, wherein a first magnetic force exists between said first magnetic part and said second magnetic part.

13. The electronic device of claim 12, wherein said moving component is movable between a cover closing position and a cover opening position along said guiding component, said cover closing position is located between said magnetic part and said cover opening position, and said moving component presses said first elastic part to generate a first restoring force smaller than and opposite to said first magnetic force and stays in said cover closing position when said moving component is in said cover closing position.

14. The electronic device of claim 13, wherein said electronic device is in standby state when said moving component is in said cover closing position.

15. The electronic device of claim 13, wherein said electronic device is in operation state and said first restoring force is larger than said first magnetic force when said moving component is in said cover opening position.

16. The electronic device of claim 11, wherein said moving component further includes first force receiving part for receiving a component force generated along said guiding component from an external force.

17. The electronic device of claim 16, wherein said first force receiving part includes an inclinatory surface for redirecting the external force exerted on the inclinatory surface to a direction along the guiding component.

18. The electronic device of claim 16 further comprises a first force-exerting component, wherein said first force-exerting component is disposed corresponding to said first force receiving part.

19. The electronic device of claim 18, wherein said first force-exerting component is disposed outside said shell and is movable toward said base.

20. The electronic device of claim 18, wherein said first force-exerting component further includes a rebound elastic part, wherein said rebound elastic part is disposed to deform in a direction toward said base and generate a first rebound force when said first force-exerting component moves toward said base.

21. The electronic device of claim 11, wherein said base further includes a third magnetic part, wherein said third magnetic part is disposed in the opposite side of said base opposite to said first magnetic part.

22. The electronic device of claim 21, wherein said moving component further includes a fourth magnetic part, wherein said fourth magnetic part is disposed corresponding to said third magnetic part.

23. The electronic device of claim 22 further comprises a second elastic member being disposed between said base and said fourth magnetic part of said moving component to exert an elastic force on said moving component.

24. The electronic device of claim 23, wherein a second magnetic force exists between said third magnetic part and said fourth magnetic part.

25. The electronic device of claim 24, wherein said moving component is movable between a third position and a fourth position along said guiding component, said third position is disposed between said third magnetic part and said fourth position, said moving component presses said second elastic part to generate a second restoring force smaller than and opposite to said second magnetic force and stays in said third position when said moving component is in said third position.

26. The electronic device of claim 25, wherein said second restoring force is larger than said second magnetic force when said moving component is in said fourth position.

27. The electronic device of claim 26, wherein said moving component further includes a second force receiving part for receiving a component force generated along said guiding component from an external force.

28. The electronic device of claim 27, wherein said second force receiving part includes a inclinatory surface for redirecting the external force exerted on the inclinatory surface to a direction along the guiding component.

29. The electronic device of claim 27 further comprises a second force-exerting component, wherein said second force-exerting component is disposed corresponding to said second force receiving part.

30. The electronic device of claim 29, wherein said second force-exerting component is disposed outside said shell and is movable toward said base.
